(19) United States
(12) Patent Application Publication
(10) Pub. No.: US 2007/0168253 A1
(43) Pub. Date: Jul. 19, 2007

(54) Retail outlet, article of clothing and method of promoting sale of same

(76) Inventor: Lafayette Lever, Chandler, AZ (US)

Correspondence Address: TOD R NISSLE, PO BOX 55630, PHOENIX, AZ, 85078, US

(21) Appl. No.: 11/655,020

(22) Filed: Jan. 18, 2007

Related U.S. Application Data
(60) Provisional application No. 60/760,021, filed on Jan. 18, 2006.

(51) Int. Cl. G06Q 99/00; G07G 1/14; G06Q 30/00

(52) U.S. Cl. 705/14; 705/1

(57) ABSTRACT

A retail outlet includes a building structure comprising an arena housing a sporting event for a particular sport. The building structure is located in a selected country. A point of sale in the building structure offers jerseys for sale while the sporting event is ongoing. The jerseys are of a type utilized in the particular sport and include the name of a participant in the sporting event, the participant comprising a professional athlete recognized in the selected country and being a member of a foreign professional league for the particular sport. The professional league normally competes in a country different from the selected country. The jerseys also include at least one logo of said foreign professional league, and an indicia of the country of citizenship of the participant. The country of citizenship corresponds to the selected country, and the indicia is selected from a group consisting of the flag of the country of citizenship, the name of the country of citizenship, and at least one color of the flag of the country of citizenship.

This application claims priority based up on U.S. Provisional Application Ser. No. 60/760,021 filed Jan. 18, 2006.

This invention pertains to retail outlets and to promoting professional sports leagues and the sale of merchandise associated with professional sports leagues. Sports organizations, in particular professional sports leagues like the National Football League (NFL), National Basketball Association (NBA), National Hockey League (NHL), and Major League Baseball (MLB), constantly pursue avenues to raise revenue and improve the public image of their associations.

Accordingly, it would be highly desirable to provide an improved retail outlet and process to improve the public image of professional sports leagues and to facilitate the sale of jerseys and other merchandise associated with the leagues.

Therefore, it is a principal object of the invention to provide an improved retail outlet for merchandising goods for professional sports leagues and to provide an improved method of enhancing the public image of such leagues in the United States and throughout the world.

These and other, further and more specific objects and advantages of the invention will be apparent to those skilled in the art from the following detailed description thereof, taken in conjunction with the drawings, in which:

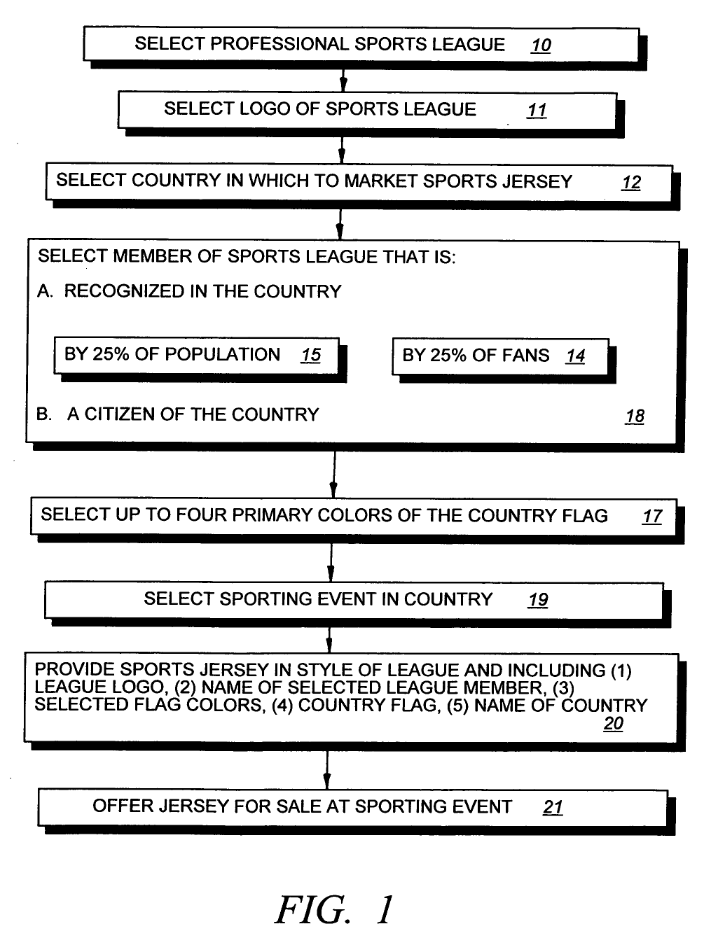

FIG. 1 is block flow diagram illustrating one embodiment of providing a retail outlet in accordance with the principles of the invention;

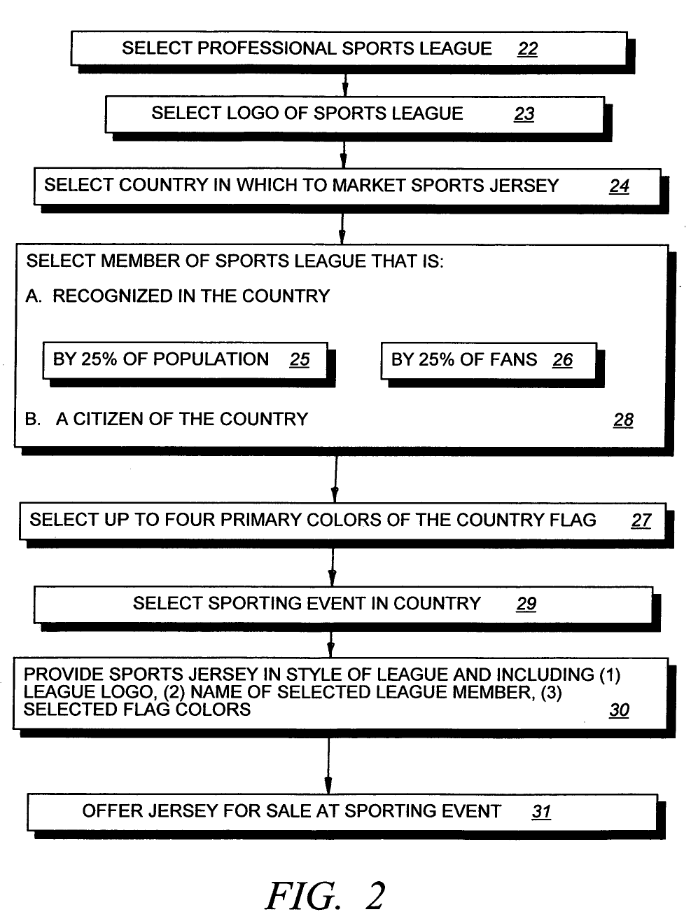

FIG. 2 is block flow diagram illustrating another embodiment of providing a retail outlet in accordance with the principles of the invention;

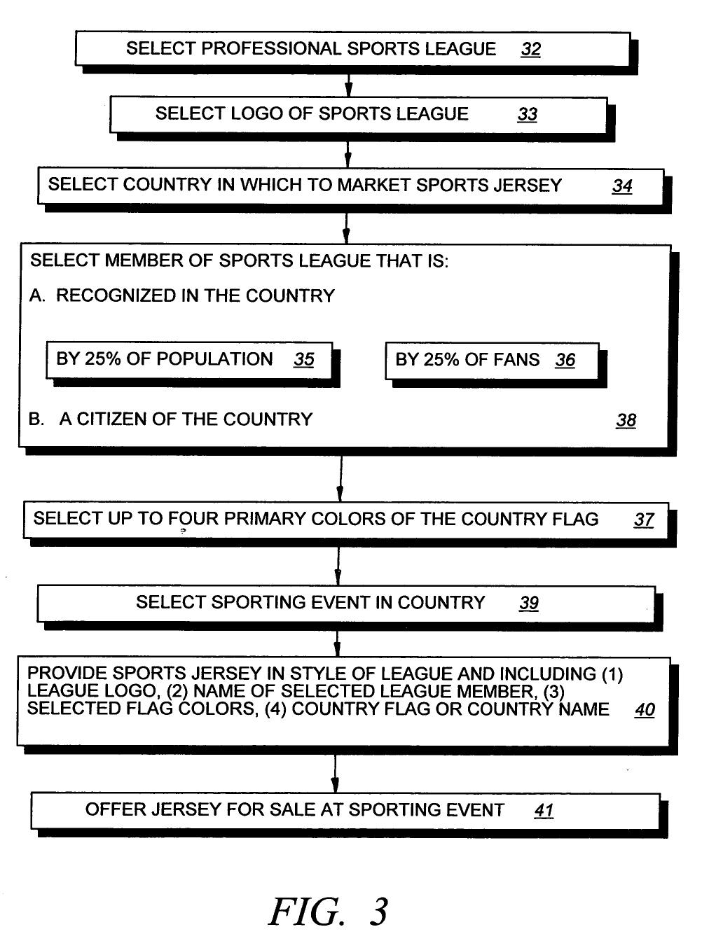

FIG. 3 is a block flow diagram illustrating still another embodiment of providing a retail outlet;

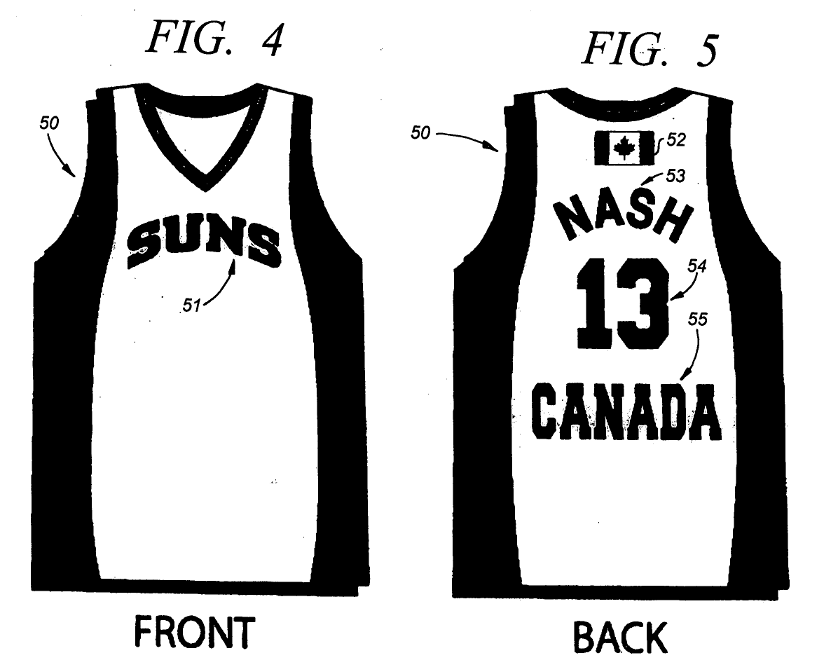

FIG. 4 is a front view of a sports jersey provided in accordance with the invention;

FIG. 5 is a back view of the sports jersey of FIG. 4;

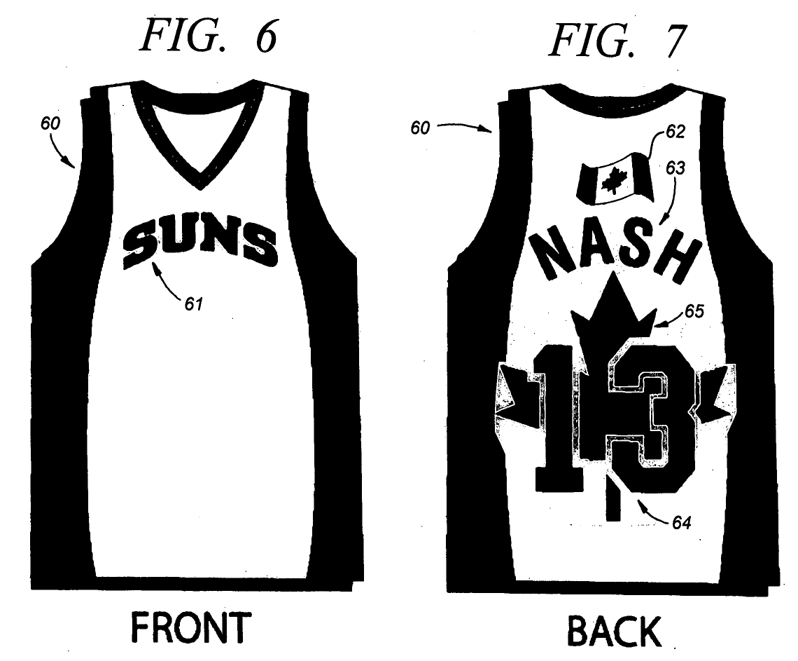

FIG. 6 is a front view of another sports jersey provided in accordance with the invention; and,

FIG. 7 is a back view of the sports jersey of FIG. 6.

Briefly, in accordance with my invention, I provide an improved retail outlet. The outlet includes a building structure comprising an arena housing a sporting event for a particular sport. The building structure is located in a selected country. A point of sale in the building structure offers jerseys for sale while the sporting event is ongoing. The jerseys are of a type utilized in the particular sport and include the name of a participant in the sporting event, the participant comprising a professional athlete recognized in the selected country and being a member of a foreign professional league for the particular sport. The professional league normally competes in a country different from the selected country. The jerseys also include at least one logo of said foreign professional league, and an indicia of the country of citizenship of the participant. The country of citizenship corresponds to the selected country, and the indicia is selected from a group consisting of the flag of the country of citizenship, the name of the country of citizenship, and at least one color of the flag of the country of citizenship. In another embodiment of the invention, the professional league competes in the selected country and is not a foreign league; and, the country of citizenship is different than the selected country.

In a further embodiment of the invention, I provide an improved method of constructing a retail outlet. The method includes the steps of providing a building structure comprising an arena housing a sporting event for a particular sport, the building structure being located in a selected country; providing a point of sale in the building structure while the sporting event is ongoing; and, providing jerseys for sale at the point of sale. The jerseys are of a type utilized in said particular sport and include the name of a participant in the sporting event. The participant comprises a professional athlete recognized in the selected country and is a member of a foreign professional league for the particular sport. The professional league normally competes in a country different from said selected country. The jerseys also include at least one logo of a foreign professional league, and an indicia of the country of citizenship of the participant. The country of citizenship corresponds to the selected country. The indicia is selected from a group consisting of the flag of the country of citizenship, the name of the country of citizenship, and at least one color of the flag of the country of citizenship. In another embodiment of the invention, the professional league competes in the selected country and is not a foreign league; and, the country of citizenship is different from the selected country.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 illustrates a process to produce a retail outlet and to market jerseys associated with a particular sports league. The process includes the steps of select a professional sports league 10, select at least one logo of the sports league 11, select a country in which to market sports jersey associated with the sport conducted in the league 12, and select a member of the sports league that is recognized in the selected country and that is a citizen of the country 18. A member of the sports league is recognized in a country if in the country at least 25% of the population recognize the name of the member of the sports league as a celebrity or well known person 15, and/or at least 25% of the fans of that particular sport in that particular country recognize the name of the member of the sports league and recognize that the member plays or coaches in that league 14. A person is a fan if the person attends or watches at least five (5) amateur or professional games a year in that particular sport. The process of FIG. 1 also includes the steps of selecting up to four primary colors of the country flag 17, of selecting a sporting event in the selected country 19, and of providing a sports jersey in the style of the sports league 20 and including at least one league logo, the name of the selected league member, the selected flag color(s), the flag of the selected country, and the name of the country. Finally, the process of FIG. 1 includes the step of offering the sports jersey for sale at the selecting sporting event 21. The league logo can comprise a logo utilized to indicate the league as a whole. An example of this kind of logo is the red and blue Major Baseball League design of a batter holding a bat. The league logo can also comprise a logo utilized by a team in the league. An example of this kind of logo is the word “SUNS” utilized by the Phoenix Suns basketball team in the NBA (National Basketball Association). Another example of a league logo is the star design utilized by the Dallas Cowboys of the NFL. The name of the league member can comprise, as desired, the last name, first name, nickname (i.e., “SHAQ”), initials (i.e., “MJ” for Michael Jordan in the NBA), or full name of the player. Any number of flag colors can be utilized, but practically speaking, typically one to four colors, more likely two or three, are utilized on a jersey. In one embodiment of the invention, the country selected in step 12 is a foreign country in which the sports league normally does not play, and the selected league member is a citizen of the foreign country. The selected league member preferably, but not necessarily, participates in the selected sporting event and the selected sporting event is a sport equivalent to the sport of the selected sports league 10. In another embodiment of the invention, the country selected in step 12 is the country in which the sports league normally does play, and the selected league member is not a citizen of the country selected. In a further embodiment of the invention, the country selected in step 12 is the country in which the sports league normally does play, and the selected league member is a citizen of the country selected.

FIG. 2 illustrates another process to produce a retail outlet and to market jerseys associated with a particular sports league. The process includes the steps of select a professional sports league 22, select at least one logo of the sports league 23, select a country in which to market sports jersey associated with the sport conducted in the league 24, and select a member of the sports league that is recognized in the selected country and that is a citizen of the country 28. A member of the sports league is recognized in a country if in the country at least 25% of the population recognize the name of the member of the sports league as a celebrity or well known person 25, and/or at least 25% of the fans of that particular sport in that particular country recognize the name of the member of the sports league and recognize that the member plays or coaches in that league 26. A person is a fan if the person attends or watches at least five (5) amateur or professional games a year in that particular sport. The process of FIG. 2 also includes the steps of selecting up to four primary colors of the country flag 27, of selecting a sporting event in the selected country 29, and of providing a sports jersey in the style of the sports league 30 and including at least one league logo, the name of the selected league member, and the selected flag color(s). Finally, the process of FIG. 2 includes the step of offering the sports jersey for sale at the selecting sporting event 31. The league logo can comprise a logo utilized to indicate the league as a whole. An example of this kind of logo is the red and blue Major Baseball League logo of a batter holding a bat. The league logo can also comprise a logo utilized by a team in the league. An example of this kind of logo is the word “SUNS” utilized by the Phoenix Suns basketball team in the NBA (National Basketball Association). The name of the league member can comprise, as desired, the last name, first name, nickname (i.e., “SHAQ”), initials (i.e., “MJ” for Michael Jordan in the NBA), or full name of the player. Any number of flag colors can be utilized, but practically speaking, typically one to four colors, more likely two or three, are utilized on a jersey. Any number of flag colors can be utilized, but practically speaking, typical one to four colors, more likely two or three, are utilized on a jersey. In one embodiment of the invention, the country selected in step 24 is a foreign country in which the sports league normally does not play, and the selected league member is a citizen of the foreign country. The selected league member preferably, but not necessarily, participates in the selected sporting event and the selected sporting event is a sport equivalent to the sport of the selected sports league 22. In another embodiment of the invention, the country selected in step 24 is the country in which the sports league normally does play, and the selected league member is not a citizen of the country selected. In a further embodiment of the invention, the country selected in step 24 is the country in which the sports league normally does play, and the selected league member is a citizen of the country selected.

FIG. 3 illustrates a further process to produce a retail outlet and to market jerseys associated with a particular sports league. The process includes the steps of select a professional sports league 32, select at least one logo of the sports league 33, select a country in which to market sports jersey associated with the sport conducted in the league 34, and select a member of the sports league that is recognized in the selected country and that is a citizen of the country 38. A member of the sports league is recognized in a country if in the country at least 25% of the population recognize the name of the member of the sports league as a celebrity or well known person 35, and/or at least 25% of the fans of that particular sport in that particular country recognize the name of the member of the sports league and recognize that the member plays or coaches in that league 36. A person is a fan if the person attends or watches at least five (5) amateur or professional games a year in that particular sport. The process of FIG. 3 also includes the steps of selecting up to four primary colors of the country flag 37, of selecting a sporting event in the selected country 39, and of providing a sports jersey in the style of the sports league 40 and including at least one league logo, the name of the selected league member, the selected flag color(s), and the flag of the selected country or the name of the country. Finally, the process of FIG. 3 includes the step of offering the sports jersey for sale at the selecting sporting event 41. The league logo can comprise a logo utilized to indicate the league as a whole. An example of this kind of logo is the red and blue Major Baseball League logo of a batter holding a bat. The league logo can also comprise a logo utilized by a team in the league. An example of this kind of logo is the word “SUNS” utilized by the Phoenix Suns basketball team in the NBA (National Basketball Association). The name of the league member can comprise, as desired, the last name, first name, nickname (i.e., “SHAQ”), initials (i.e., “MJ” for Michael Jordan in the NBA), or full name of the player. Any number of flag colors can be utilized, but practically speaking, typically one to four colors, more likely two or three, are utilized on a jersey. In one embodiment of the invention, the country selected in step 34 is a foreign country in which the sports league normally does not play, and the selected league member is a citizen of the foreign country. The selected league member preferably, but not necessarily, participates in the selected sporting event and the selected sporting event is a sport equivalent to the sport of the selected sports league 32. In another embodiment of the invention, the country selected in step 34 is the country in which the sports league normally does play, and the selected league member is not a citizen of the country selected. In a further embodiment of the invention, the country selected in step 34 is the country in which the sports league normally does play, and the selected league member is a citizen of the country selected.

FIGS. 4 and 5 illustrate by way of example and not limitation one sports jersey, namely a basketball jersey, made in accordance with the invention. The jersey is for Steve Nash, a well known basketball player for the Phoenix Suns basketball team of the NBA (National Basketball Association). Since Mr. Nash is a Canadian citizen, the jersey of FIGS. 4 and 5 would preferably be utilized in a retail outlet in an arena during a basketball sporting event in Canada in which Mr. Nash would be participating. The jersey 50 includes a logo 51 of the NBA, namely the “SUNS” logo 51. Jersey 50 also includes the flag 52 of Canada, includes the name 53 (i.e., “NASH”) of Mr. Nash, includes the number (i.e., “13”) 54 of Mr. Nash, and includes the country of citizenship (i.e., “CANADA”) 55 of Mr. Nash. Although not apparent from FIGS. 4 and 5, the dark or black portions of jersey 50 would be red, and the white portions of the jersey would be white, with the colors of red and white corresponding to the principal colors of the Canadian flag. When jersey 50 is offered for sale during a basketball game in an arena in Canada in which Mr. Nash is participating, the use of jersey not only generates goodwill for and promotes the NBA and the United States, but draws upon the natural patriotism of Canadian citizens that are attending the event on Canadian soil during an ongoing sporting event and watching a famous Canadian citizen play professional basketball with the flag and/or flag colors and/or country name on the basketball jersey of the Canadian citizen. Providing a retail outlet to market jerseys designed in accordance with the invention at an ongoing sporting event in an arena in the country of citizenship of the player is critical in the practice of the invention and is effective in marketing jerseys and promoting in a good light the NBA or other selected professional sports organization. Mr. Nash is a recognized in Canada both because at least 25% of the population recognize him as a celebrity or well known public figure and because at least 25% of the basketball fans in Canada recognize Mr. Nash's name and know he is a player in the NBA 26. Providing a retail outlet to market jerseys designed in accordance with the invention at an ongoing sporting event in an arena in a country where the player is not a citizen can also be effective in marketing jerseys and promoting in a good light the NBA or other selected professional sports organization.

FIGS. 6 and 7 illustrate by way of example and not limitation another sports jersey, a basketball jersey, made in accordance with the invention. The jersey is also for Steve Nash, a well known basketball player for the Phoenix Suns basketball team of the NBA (National Basketball Association). Since Mr. Nash is a Canadian citizen, the jersey of FIGS. 6 and 7 would preferably be utilized in a retail outlet in an arena during a basketball sporting event in Canada in which Mr. Nash would be participating. The jersey 60 includes a logo 51 of the NBA, namely the “SUNS” logo 61. Jersey 60 also includes the flag 62 of Canada, includes the name 63 (i.e., “NASH”) of Mr. Nash, includes the number (i.e., “13”) 65 of Mr. Nash, and includes a maple leaf indicating and directly associated with the country of citizenship 65 of Mr. Nash. The maple leaf is the prominent symbol on the Canadian flag. Although not apparent from FIGS. 6 and 7, the dark or black portions of jersey 60 would be red, and the white portions of the jersey would be white, with the colors of red and white corresponding to the principal colors of the Canadian flag. When jersey 60 is offered for sale during a basketball game in an arena in Canada in which Mr. Nash is participating, the use of jersey not only generates goodwill for and promotes the NBA and the United States, but draws upon the natural patriotism of Canadian citizens that are attending the event on Canadian soil during an ongoing sporting event and watching a famous Canadian citizen play professional basketball with the flag and/or flag colors and/or country name on the basketball jersey of the Canadian citizen. Providing a retail outlet with the particular setting in an ongoing sporting event in an arena in the country of citizenship of the player is critical in the practice of the invention and is effective in marketing jerseys and promoting in a good light the NBA or other selected professional sports organization.

As would be understood by those of skill in the art, the invention can be utilized in conjunction with any player in any professional sports league in any country, preferably in the country of citizenship of the player. In some instances, it may be beneficial for well recognized players to wear jerseys of the general type illustrated in FIGS. 4 to 7 in countries in which the players are not citizens, particularly if the players has in a sense immigrated to a country and is in the process of becoming a citizen of the country, or, if the player consider the country “home” even though the player has not taken the steps necessary to become a citizen of that country.

Having described my invention in such terms as to enable those of skill in the art to make and practice it, and having described the presently preferred embodiments thereof, I Claim:

1. A retail outlet comprising
(a) a building structure comprising an arena housing a sporting event for a particular sport, said building structure located in a selected country;
(b) a point of sale in said building structure while said sporting event is ongoing; and,
(c) jerseys for sale at said point of sale, said jerseys being of a type utilized in said particular sport and including
(i) the name of a participant in said sporting event, said participant comprising a professional athlete recognized in said selected country and being a member of a foreign professional league for said particular sport, said professional league normally competing in a country different from said selected country,
(ii) at least one logo of said foreign professional league, and
(iii) an indicia of the country of citizenship of the participant, said country of citizenship corresponding to said selected country, said indicia being selected from a group consisting of the flag of said country of citizenship, the name of said country of citizenship, and at least one color of the flag of said country of citizenship.

2. A method of constructing a retail outlet, comprising the steps of
(a) providing a building structure comprising an arena housing a sporting event for a particular sport, said building structure located in a selected country;
(b) providing a point of sale in said building structure while said sporting event is ongoing; and,
(c) providing jerseys for sale at said point of sale, said jerseys being of a type utilized in said particular sport and including
(i) the name of a participant in said sporting event, said participant comprising a professional athlete recognized in said selected country and being a member of a foreign professional league for said particular sport, said professional league normally competing in a country different from said selected country,
(ii) at least one logo of said foreign professional league, and
(iii) an indicia of the country of citizenship of the participant, said country of citizenship corresponding to said selected country, said indicia being selected from a group consisting of the flag of said country of citizenship, the name of said country of citizenship, and at least one color of the flag of said country of citizenship.

3. The retail outlet of claim 1 wherein
(a) said professional league competes in said selected country and is not a foreign league; and,
(b) said country of citizenship is different than said selected country.

4. The method of claim 2 wherein
(a) said professional league competes in said selected country and is not a foreign league; and,
(b) said country of citizenship is different than said selected country.
